(19) United States
(12) Patent Application Publication
(10) Pub. No.: US 2024/0427651 A1
(43) Pub. Date: Dec. 26, 2024

(54) SYSTEMS AND METHODS FOR PROCESSING DATA STREAMS

(71) Applicant: MongoDB, Inc., New York, NY (US)

(72) Inventors: Kenneth Gorman, Austin, TX (US); Zhanlin Shang, Ultimo (AU); Si Cong Stephen Lui, St. Leonards (AU); Erik Beebe, Austin, TX (US); Matthew Normyle, Austin, TX (US); Sandeep Dhoot, Sunnyvale, CA (US); Gustavo Tenrreiro, Cedar Park, TX (US)

(73) Assignee: MongoDB, Inc., New York, NY (US)

(21) Appl. No.: 18/748,997

(22) Filed: Jun. 20, 2024

Related U.S. Application Data
(60) Provisional application No. 63/509,405, filed on Jun. 21, 2023.

(51) Int. Cl. G06F 9/54

(52) U.S. Cl. CPC G06F 9/542; G06F 9/547

(57) ABSTRACT

Systems and computerized methods for processing data in a data stream prior to landing the data in a data sink is provided. The system may comprise at least one processor operatively connected to a memory, the at least one processor, when executing, being configured to receive data relating to a data source and data sink, wherein the data source is a boundless data source; establish, based on the received data relating to the data source and data sink, a connection between the data source and the data sink; receive event data from the data source; process the event data on an event-by-event basis; and land the processed event data into the data sink. By performing operations on data directly from the data stream, the system and computerized methods provided herein may provide real-time or near real-time data processing as event data is received from various data sources.

### CROSS-REFERENCE TO RELATED APPLICATIONS

This application claims the benefit under 35 U.S.C. § 119(e) of U.S. Provisional Application No. 63/509,405 entitled “SYSTEMS AND METHODS FOR PROCESSING DATA STREAMS,” filed Jun. 21, 2023, the entire contents of which are incorporated herein by reference by its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### SUMMARY

According to some aspects described herein, it is appreciated that it would be useful to process event data from a data stream prior to landing the data. Data streams may be a continuous source of real-time event data. Data streams may be generated by one or more sensors, devices, live data feeds, Change Data Capture (CDC), Extract Transform and Load (ETL) or Extract Load and Transform (ELT) generators, or other types of generators of streaming data. Processing event data of a data stream prior to landing the data may provide near real-time processing and analytics of a data stream. Near real-time data processing may be used by a number of systems for reacting to the data in near real-time, such is done in multiple types of systems/industries such as network security, financial services, Internet of Things (IoT), manufacturing, oil and gas, fraud/anomaly detection, algorithmic trading, predictive maintenance, device telemetry, click-stream analysis, real-time recommendation engines, among others.

In some implementations, a stream processor may be provided that is capable of processing event data from a data stream. In some embodiments, a stream processor may be used to identify events in a stream and process event data on an event-by-event basis, which may allow for near real-time processing and analysis of the event data. In some embodiment, it is appreciated that a platform that enables creation, management, and real-time processing of data stream information prior to being stored in a data storage entity would be beneficial.

According to one aspect, a system is provided. The system may comprise at least one processor operatively connected to a memory, when executing the at least one processor is configured to: receive data relating to a data source and data sink, wherein the data source is a boundless data source, establish, based on the received data relating to the data source and data sink, a connection between the data source and the data sink, receive event data from the data source, process the event data on an event-by-event basis, and landing the processed event data into the data sink.

According to one embodiment, the processing of the data stream comprises serializing the event data into BSON. According to one embodiment, the system further comprises a dead letter queue and wherein the processing of the data stream further comprises storing event data in the dead letter queue if the event data cannot be serialized.

According to one embodiment, the data relating to the data source and data sinks are credentials for the data source and data sink. According to one embodiment, the processing of the event data is based on a time window. According to one embodiment, the processing of the event data comprises grouping event data based on the time window. According to one embodiment, the event data is stored in a dead letter queue if the event data is outside of the time window. According to one embodiment, the processing of the event data stream comprises timestamping the event data.

According to one embodiment, the processing of the event data is at least one of a comparison, an expression matching, and a string manipulation. According to one embodiment, the processing of the event data further includes sampling the event data to determine at least one of a count of messages and an average size of messages.

According to one aspect, a method is provided. The method may comprise using at least one processor to: receive data relating to a data source and data sink, wherein the data source is a boundless data source, establish, based on the received data relating to the data source and data sink, a connection between the data source and the data sink, receive event data from the data source, process the event data on an event-by-event basis, and landing the processed event data into the data sink.

According to one aspect, a non-transitory computer-readable media is provided. The non-transitory computer-readable media, when executed by one or more processors on a computing device, may be operable to cause the one or more processors to perform: receiving data relating to a data source and data sink, wherein the data source is a boundless data source, establishing, based on the received data relating to the data source and data sink, a connection between the data source and the data sink, receiving event data from the data source, processing the event data on an event-by-event basis, and landing the processed event data into the data sink.

According to one embodiment, the data relating to the data source and data sink includes one or more connection strings associated with the data source and/or data sink. According to one embodiment, the data relating to the data source and data sink further comprises credentials for the data source and data sink. According to one embodiment, the data relating to the data source and data sink is received from a connection registry configured to store connection strings and metadata associated with the data source and the data sink.

According to one embodiment, the at least one processor is configured to process the event data by performing one or more database operations on the event data prior to landing the event data into the data sink. According to one embodiment, the one or more database operations comprise one or more of monitoring, timestamping, windowing, and/or checkpointing. According to one embodiment, the one or more database operations comprise aggregation operations including at least one of: comparisons of the event data, string manipulations of the event data, expression matching of the event data, and/or calculation of metrics of grouped data of the event data. According to one embodiment, the one or more database operations comprise compressing the event data.

According to one embodiment, the at least one processor is configured to process the event data by comparing the event data to reference data to identify whether the event data is fraudulent, and push the event data to a processing system configured to further process the event data is the event data is identified as fraudulent.

According to one aspect, a system is provided. The system may comprise at least one processor operatively connected to a memory, the at least one processor, when executing, is configured to: receive data relating to a data source and a plurality of data sinks; establish, based on the received data relating to the data source and data sink, a connection between the data source and each data sink of the plurality of data sinks; receive event data from the data source; process the event data on an event-by-event basis; land the processed event data into one of the plurality of data sinks; and merge the processed event data from each data sink of the plurality of data sinks into a collection.

According to one embodiment, the collection is a database configured to store processed event data from each data sink of the plurality of data sinks. According to one embodiment, the at least one processor is configured to process the event data by compressing the event data prior to landing and merging the processed event data into the database.

According to one embodiment, the data relating to the data source and the plurality of data sinks comprise one or more connection strings associated with the data source and/or plurality of data sinks. According to one embodiment, the data relating to the data source and the plurality of data sinks further comprises credentials for the data source and data sink. According to one embodiment, the data relating to the data source and the plurality of data sinks is received from a connection registry configured to store connection strings and metadata associated with the data source and the plurality of data sinks.

According to one embodiment, the at least one processor is configured to process the event data by performing one or more database operations on the event data prior to landing the event data into one of the plurality of data sinks. According to one embodiment, the at least one processor is configured to process the event data by creating a view of the event data to be used by an application, and to land the processed event data in the data sink of the plurality of data sinks associated with the application. According to one embodiment, creating the view of the event data to be used by the application comprises determining a schema associated with the application, and reformatting the event data to fit the schema.

According to one embodiment, event data is received from the data source at a stream rate of 100,000 events per second or higher. According to one embodiment, the at least one processor is configured to process the event data received at substantially a same rate as the stream rate.

According to one aspect, a computerized method of performing operations on data in a data stream is provided. The computerized method may comprise: receiving data relating to a data source and data sink, wherein the data source is a boundless data source; establishing, based on the received data relating to the data source and data sink, a connection between the data source and the data sink; receiving event data from the data source; processing the event data on an event-by-event basis; and landing the processed event data into the data sink.

According to one embodiment, the data relating to the data source and data sink comprises one or more connection strings associated with the data source and/or data sink. According to one embodiment, receiving data relating to the data source and data sink comprises receiving the data from a connection registry configured to store connection strings and metadata associated with the data source and the data sink. According to one embodiment, processing the event data comprises performing one or more database operations on the event data prior to landing the event data into the data sink. According to one embodiment, the one or more database operations comprise aggregation operations including at least one of: comparisons of the event data, string manipulations of the event data, expression matching of the event data, and/or calculation of metrics of grouped data of the event data.

According to one aspect, a system is provided. The system may comprise: at least one processor operatively connected to a memory, the at least one processor, when executing, is configured to: receive data relating to a data source and data sink; establish, based on the received data relating to the data source and data sink, a connection between the data source and the data sink; receive event data from the data source; process the event data from the data source; land the processed event data into the data sink; and perform one or more operations on the processed event data in the data sink and provide an output of the one or more operations as input to the data source.

According to one embodiment, the one or more operations performed on the processed data is configured to monitor changes on the processed event data landed in the data sink. According to one embodiment, the data sink is a change stream configured to access real-time or near real-time changes in the processed event data landed in the change stream. According to one embodiment, the data source is the change stream and the event data received from the data source include the real-time or near real-time changes in the processed event data landed in the change stream.

According to one embodiment, the one or more operations are performed as a chaining of operations on the processed event data in the data sink. According to one embodiment, the chaining of operations is implemented in an aggregation pipeline. According to one embodiment, the one or more operations are performed in different stages of the aggregation pipeline.

According to one aspect, a system is provided. The system may comprise: at least one processor operatively connected to a memory, the at least one processor, when executing, is configured to: receive data relating to a plurality of data sources and a data sink, wherein at least one of the plurality of data sources is a boundless data source; establish, based on the received data relating to the plurality of data sources and the data sinks, a connection between the plurality of data sources and the data sink; receive event data from the plurality of data sources; process the event data by performing one or more aggregation operations on the event data received from the data source; and land the processed event data into the data sink.

According to one embodiment, the one or more aggregation operations include a plurality of data operations to be executed on first event data and second event data. According to one embodiment, the first event data is received from a first data source of the plurality of data sources and the second event data is received from a second data source of the plurality of data sources.

According to one embodiment, performing one or more aggregation operations on the first and second event data received comprises identifying a common field of the first event data and the second event data. According to one embodiment, wherein performing one or more aggregation operations on the event data received from the plurality of data sources comprises: performing a first operation on the first event data to obtain a first data result; performing a second operation on the second event data to obtain a second data result; and combining the first data result and the second data result to produce the processed event data. According to one embodiment, performing one or more aggregation operations on the event data received from the plurality of data sources comprises creating an output data structure including the first data result and the second data result. According to one embodiment, wherein creating the output data structure comprises grouping the first event data and the second event data.

According to one embodiment, wherein the one or more aggregation operations include at least one of comparisons of the first and second event data, string manipulations of the first and second event data, expression matching of the first and second event data, and/or calculation of metrics of grouped data of the first and second event data.

According to one embodiment, the data relating to the data source and the data sink is received from a connection registry configured to store connection strings and metadata associated with the plurality of data sources and the data sink.

According to one aspect, a computerized method for performing operations on data in a data stream is provided. The computerized method may comprise: receiving data relating to a plurality of data sources and a data sink, wherein at least one of the plurality of data sources is a boundless data source; establishing, based on the received data relating to the plurality of data sources and the data sinks, a connection between the plurality of data sources and the data sink; receiving event data from the plurality of data sources; processing the event data by performing one or more aggregation operations on the event data received from the data source; and landing the processed event data into the data sink.

According to one embodiment, performing the one or more aggregation operations includes performing a plurality of data operations on first event data and second event data. According to one embodiment, performing the one or more aggregation operations on the first and second event data received comprises identifying a common field of the first event data and the second event data. According to one embodiment, performing the one or more aggregation operations on the event data received from the plurality of data sources comprises: performing a first operation on the first event data to obtain a first data result; performing a second operation on the second event data to obtain a second data result; and combining the first data result and the second data result to produce the processed event data. According to one embodiment, performing the one or more aggregation operations on the event data received from the plurality of data sources comprises creating an output data structure including the first data result and the second data result.

According to one aspect, a system for creating and managing stream processors is provided. The system may comprise: a management interface configured to: receive information from a user relating to a stream instance, the information including data associated with one or more data sources and/or one or more data sinks; enable the user to manage the stream instance; generate one or more connect strings for creating a stream processor associated with the stream instance; cause the system to create the stream processor associated with the created stream instance based on the one or more connect strings; and enable the user to manage the created stream processor based on one or more control inputs received from the user.

According to one embodiment, enabling the user to manage the stream instance comprises enabling the user to: create the stream instance based on the received information from the user; drop the stream instance based on the received information from the user; and store the one or more connect strings for creating the stream instance and connection data associated with the one or more data sources and/or one or more data sinks in a connection registry. According to one embodiment, dropping the stream instance comprises stopping the stream processor associated with the stream instance and returning computational resources executing the stream instance to a pool of computational resources.

According to one embodiment, the management interface is further configured to enable the user to manage the one or more connection strings and the connection data stored in the connection registry. According to one embodiment, the connection data includes credentials associated with the one or more data sources and/or the one or more data sinks. According to one embodiment, managing the one or more connection strings and the connection data stored in the connection registry comprises: configuring a data store associated with the connection string and connection data as a data source or a data sink; and specifying a configuration of the data store as a data source or a data sink.

According to one embodiment, creating the stream processor comprises establishing a connection between a first data source of the one or more data sources and a first data sink of the one or more data sinks. According to one embodiment, managing the created stream processor comprises starting, stopping, and/or deleting the created stream processor.

According to one embodiment, managing the created stream processor comprises defining one or more operations for the created stream processor to perform on event data received from the first data source prior to landing the event data in the first data sink. According to one embodiment, the one or more operations comprise an aggregation operation configured to process first event data from the one or more data sources and second event data received from the one or more data sources prior to landing the processed event data in the first data sink. According to one embodiment, the aggregation operation comprises: a first operation to be performed on the first event data to obtain a first data result; a second operation to be performed on the second event data to obtain a second data result; and a merge operation to combine the first data result and the second data result to produce the processed event data. According to one embodiment, defining one or more operations comprises defining an output data structure for the processed event data including the first data result and the second data result.

According to one embodiment, the management interface comprises: a stream instance component configured to: receive the information from the user; enable the user to manage the stream instance; and generate the one or more connection strings for creating the stream processor associated with the stream instance based on the information received from the user; and a stream processor component configured to: receive the one or more connection strings generated by the stream instance component based on input from the user; cause the system to create the stream processor associated with the created stream instance based on the received one or more connection strings; and enable the user to manage the created stream processor based on one or more control inputs received from the user.

According to one embodiment, the stream instance component is a command line interface. According to one embodiment, the stream processor component is a driver interface. According to one embodiment, the management interface comprises an application programming interface configured to receive information from one or more data stream platforms.

According to one aspect, a method for creating and managing stream processors is provided. The method may comprise: using a management interface executed on a computing device configured to facilitate interaction between a user and the stream processors by: receiving information from a user relating to a stream instance, the information including data associated with one or more data sources and/or one or more data sinks; enabling the user to manage the stream instance; generating one or more connect strings for creating a stream processor associated with the stream instance; causing creation of the stream processor associated with the created stream instance based on the one or more connect strings; and enabling the user to manage the created stream processor based on one or more control inputs received from the user.

According to one embodiment, enabling the user to manage the stream instance comprises enabling the user to: create the stream instance based on the received information from the user; drop the stream instance based on the received information from the user; and store the one or more connect strings for creating the stream instance and connection data associated with the one or more data sources and/or one or more data sinks in a connection registry.

According to one embodiment, enabling the user to manage the stream instance comprises enabling the user to manage the one or more connection strings and the connection data stored in the connection registry. According to one embodiment, managing the one or more connection strings and the connection data stored in the connection registry comprises: configuring a data store associated with the connection string and connection data as a data source or a data sink; and specifying a configuration of the data store as a data source or a data sink.

According to one embodiment, creating the stream processor comprises establishing a connection between a first data source of the one or more data sources and a first data sink of the one or more data sinks. According to one embodiment, managing the created stream processor comprises defining one or more operations for the created stream processor to perform on event data received from the first data source prior to landing the event data in the first data sink. According to one embodiment, the one or more operations comprises an aggregation operation configured to process first event data from the one or more data sources and second event data received from the one or more data sources prior to landing the processed event data in the first data sink.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence is intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a block diagram of an example system used to for stream processing, according to some embodiments, according to some embodiments.

FIG. 2 shows a block diagram of an example stream processor, according to some embodiments, according to some embodiments.

FIG. 3 shows an example flow chart of the stream processor states, according to some embodiments, according to some embodiments.

FIG. 4 shows an example process of starting a stream processor for processing streaming data, according to some embodiments.

FIG. 5 shows an example process of pushing event data into a dead letter queue, according to some embodiments.

FIG. 6 shows a block diagram of an example system configured to process data streams in near real-time for fraud detection, according to some embodiments.

FIG. 7 shows another block diagram of an example system configured to perform stream processing, according to some embodiments.

FIG. 8 depicts an exemplary architecture for implementing a stream processing environment configured to enable a user to one or more stream processors, according to some embodiments.

### DETAILED DESCRIPTION

As discussed above, in many circumstances, it may be beneficial to process event data from a data stream prior to landing data. For example, certain industries certain industries produce data that may be time-sensitive and/or may have rapidly depreciating value. Near real-time data processing may be beneficial to industries such as security, financial services, Internet of Things (IoT), manufacturing, oil and gas, fraud/anomaly detection, algorithmic trading, predictive maintenance, device telemetry, click-stream analysis, real-time recommendation engines, among others. Processing event data of a data stream prior to landing the data may provide these systems and industries near real-time processing and analytics of data.

Conventional systems typically do not provide the functionality that may be used to perform this real-time or near real-time data processing. For example, it is common to observe events in a stream being created at a rate of 100,000 events per second or higher, a throughput number typically tricky for databases to handle as pure inserts. As such, to get a similar real-time result, users typically need to pull functionality and components from various vendors and implement tricky and complex configurations in a way that induces opaqueness and lacks robust stateful operations. Further, conventional systems typically utilize structured query language (SQL) based processing which imposes a rigid nature on the SQL processing and related schemas. In that way, conventional systems undermine the near real-time data processing that is helpful in systems and industries where the value of the data is inherently time-sensitive and diminishes quickly. As such, the inventors have developed systems and methods described herein for enabling integrated and streamlined interaction between users and streamed data directly from a data stream. In some implementations, event data is encoded into Binary JSON (BSON) format which allows binary-encoded serialization of event data.

As discussed, various aspects relate to processing data streams prior to landing the data in a database (e.g., a document database such as the MongoDB Atlas database system or other database type). Data streams may be a boundless source of near real-time event data. Data streams may be processed by a stream processor, which may have a definition that specifies the configuration and properties of the stream processor.

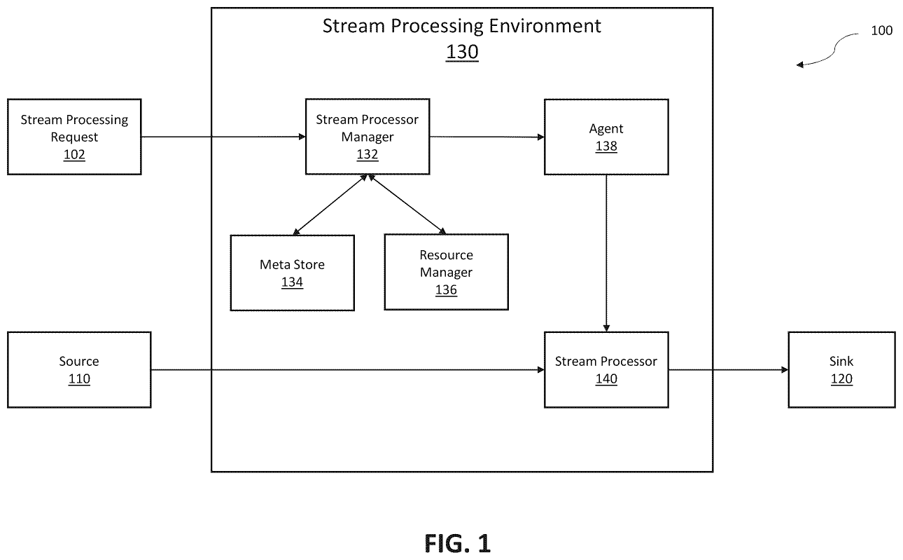

FIG. 1 shows a block diagram of an example system 100 used to process data streams, according to some embodiments. System 100 may be implemented to fulfill processing of streaming data from a source 110. Source 110 may be any suitable data source for providing streaming data. For example, source 110 may be an external source including streaming platforms (e.g., Kafka clusters including Confluent Cloud, AWS MSK), one or more sensors, live data feeds, or may be an internal source such as a database. In some embodiments, source 110 may be a boundless data source. A source 110 may provide a data stream, which may comprise of event data. In some embodiments, a data stream may be generated by one or more systems such as those that may typically create data streams or event data such as in manufacturing, financial services, internet of things (IoT), network security, oil and gas, aerospace, or other types of systems. In some embodiments, streaming data may be generated by one or more sensors, devices, streaming platforms, live data feeds, change data capture (CDC), ETL/ELT, or other types of generators of streaming data. Although only one source 110 is shown in FIG. 1, it can be appreciated that the example system 100 may include more than one source 110 to process data from more than one source 110 concurrently.

A data stream from the source 110 may be fed to the stream processor 140. The stream processor 140 may configured to connect a source 110 to a sink 120 and process and/or analyze data streams prior to landing the data in the sink 120. Stream processor 140 may perform various processes on the data stream. In some embodiments, stream processor 140 may process the data stream on an event-by-event basis. In some embodiments, stream processor 140 may serialize the event data into a document format (e.g., BSON format), validate the data, sample the data, perform comparisons, perform string manipulations, among other processes. The stream processor 140 may then land the processed data into the data sink 120. Sink 120 may be a database, data lake, change stream, streaming platform, among others. Although only one sink 120 is shown in FIG. 1, it can be appreciated that a system 100 may include more than one sink 120 into which event data from the data stream can be landed.

In some embodiments, applications running on end user devices may be programmed to use the data from the sink (e.g., database) for underlying data management functions. For example, processing and/or analyzing event data in data streams may include creating a view of the event data to be used by the particular application and the sink in which the data is landed may be a sink associated with the particular application, or a sink in which the particular application is otherwise configured to retrieve data from. Creating a view of the event data may include determining a schema associated with the application (e.g., a schema for the data that can be used by the application) and reformatting the event data to fit the determined schema. In some embodiments, the data sink 120 may be a NoSQL database. In some embodiments, a NoSQL database may allow the stream processor to land streaming data from multiple data sinks and merge the processed data from multiple data sinks into a collection in the database. For example, the database may be configured to store data in collections as documents in a dynamic schema.

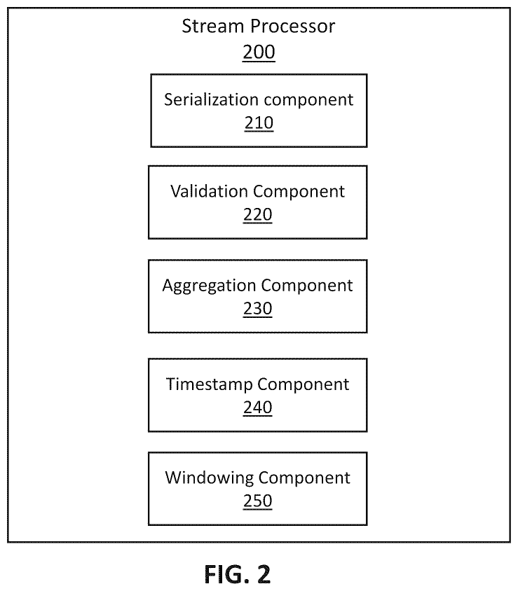

In some embodiments, system 100 may include a stream processing environment 130 to fulfill stream processing and stream processing requests. For example, stream processing environment 130 may be configured to fulfill requests related to landing streams into the environment through executing read and write operations (e.g., reading Kafka data, writing to a database for querying). Stream processing environment 130 may similarly be configured to publish events from the environment, for example, to capture events for downstream systems via watching a change stream and generating events and messages in an event bus. The stream processing environment 130 may include a stream processor 140 configured to process data streams from the source 110 and land processed data in the sink 120. For example, stream processor 140 may be configured to perform one or more operations on data in the data streams from source(s) 110 prior to landing the data into sink(s) 120, details of which will be discussed further with respect to FIG. 2 below.

Stream processing environment 130 may also include a stream processor manager 132 configured to receive stream processing requests 102. Stream processing requests 102 may include creating a stream processor instance, starting a stream processor, stopping a stream processor, and dropping a stream processor. After receiving a stream processing request 102, stream processor manager 132 may communicate with meta store 134, which may include one or more metadata clusters associated with various stream processor instances. Meta store 134 may store metadata about stream processors including configuration metadata, information pertaining to the source and sink, connection strings associated with cloud providers, and credentials pertaining to the source and sink. Stream processor manager 132 may access metadata related to the stream processing request and then communicate with the resource manager 136 for provisioning services and compute resources.

Once provisioning services and compute resources has been completed, stream processor manager 132 may then communicate with the agent 138 to run the stream processor. Agent 138 may broker communications (e.g., start, stop, drop, etc.) to at least one stream processor 140. In some embodiments, agent 138 may also monitor and report status changes and metrics of at least one stream processor 140. Status changes and metrics of the stream processor 140 may include the count of events, average size of events, lag of incoming event data, state storage size, and degree of parallelism.

In some embodiments, stream processing environment 130 may be implemented as a standalone service hosted on any suitable system, for example, a container-based system (e.g., SRE Kube). In other embodiments, stream processing environment 130 may be implemented as an addition to an existing service. An existing query engine may be modified to support the functionality of stream processing environment 130. For example, the query engine may include a distributed query engine (e.g., Atlas Data Federation (ADF)) configured to natively query, transform, and move data across various sources. However, the technology is not limited in this manner and stream processing environment 130 may be implemented in any suitable manner and/or by any suitable system.

FIG. 2 shows a block diagram of an example stream processor, according to some embodiments. Stream processor 200 may be configured to perform a number of processes including serialization, validation, aggregation, timestamping, windowing, checkpointing, among other processes. In some embodiments, stream processor 200 may be configured to perform one or more operations on data in a data stream prior to landing the data in a data sink (e.g., a database). The one or more operations may include the processes listed above, database operations (e.g., queries, query resumption, etc.), aggregation operations, chaining or pipelining operations, and/or any other operations. In some embodiments, stream processor 200 may include one or more components configured to perform the one or more operations described herein. For example, stream processor 200 may include serialization component 210, validation component 220, aggregation component 230, timestamp component 240, windowing component 250, and/or any other component suitable for performing any of the operations and functions described herein. In some embodiments, stream processor 200 may be incorporated into the stream processing environment 130.

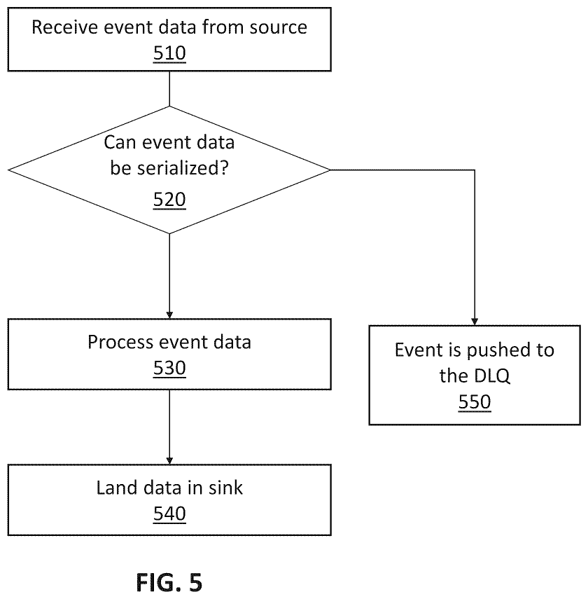

Stream processor 200 may include a serialization component 210 for serializing incoming streaming data. Serialization component 210 serialize the streaming data into a binary encoded JavaScript Object Notation (BSON) document as discussed above. Serialization component 210 may be configured to perform JavaScript Object Notation (JSON), Avro, protobuf, string and other serialization protocols. In some embodiments, if serialization component 210 fails to serialize the streaming data, then the streaming data and/or the error message will be pushed to a dead letter queue (DLQ) to later be inspected, described further below with respect to FIG. 5. In some embodiments, the DLQ may be stored in a database cluster or instance such that the user may access the storage. Pushing event data that failed to be serialized may ensure that the system does not stop or crash.

Stream processor 200 may also include a validation component 220. Validation component 220 may inspect the event data and/or the serialized event data to ensure that the data conforms to the validation rules. In some embodiments, validation rules may be defined by the user. Validation rules may include requiring a field to have a minimum string length, requiring a field to be of a specified data type, etc. If an event data and/or serialized event data does not conform to the validation rules, then the event data may be pushed to the DLQ to later be inspected. Pushing event data whose format does not match the validation rules may ensure that the system does not stop or crash.

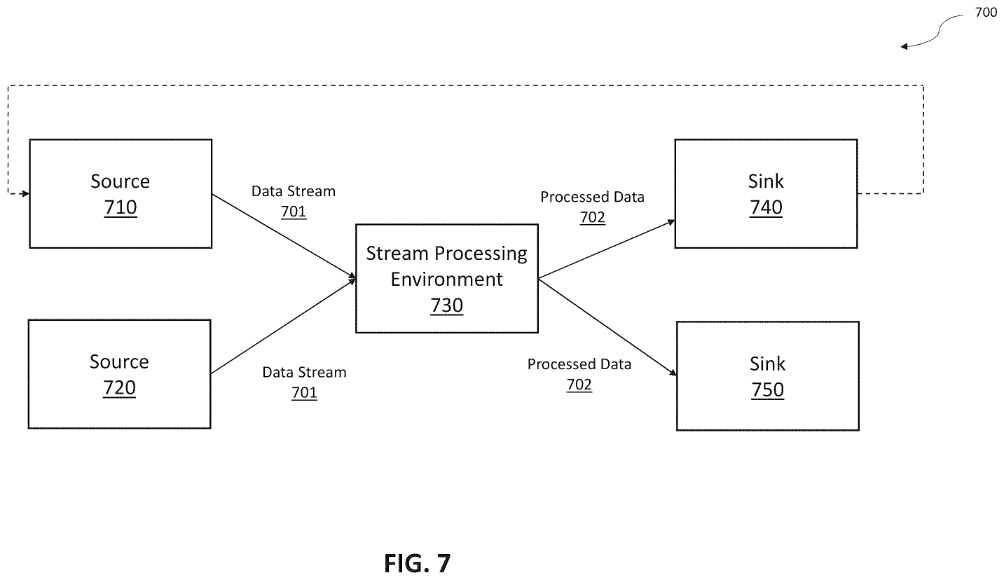

Further, stream processor 200 may include an aggregation component 230 configured to process the serialized data. In some embodiments, aggregation component 230 may perform comparisons, string manipulations, expression matching, calculate metrics of grouped data (e.g., totals, averages, maximums, etc.), among other functions and/or processes. As will be discussed further below with respect to FIG. 7, aggregation component 230 may be configured to chain operations in a pipelined form so as to enable the continuous processing of data.

In some embodiments, it can be appreciated that stream processor may be configured to process stream data (e.g., serialized data) in the data stream in an aggregated fashion. For example, the streaming data may include event data representing a first time window and event data representing a second time window. Alternatively or additionally, the stream data may include event data received from a first data source and event data received from a second data source. The stream processor may process the first event data and the second event data concurrently. As such, in some embodiments, stream processor may be configured to perform, using aggregation component 230, one or more aggregation operations on the first and second event data in the data stream.

The one or more aggregation operations may include data operations to be executed on the first and second event data, for example, comparisons between event data from the first and second event data, string manipulations on the first and second event data, metric calculations on the first and second event data, transformation operations for accessing and operating on the first and second event data, filtering operations (e.g., $match, $skip, etc.) or any other suitable functions or processes.

In some embodiments, performing one or more aggregation operations on the first and second event data may comprise performing the operations in stages. In some embodiments, an aggregation operation may be configured to perform a first operation on the first event data to obtain a first data result and perform a second operation on the second event data. For example, the first operation may be a transformation operation to access and evaluate particular data from the first event data and the second operation may be a transformation operation to access and evaluate particular data from the second event data.

In some embodiments, the aggregation operation may include identifying a common data field of the first and second event data. For example, event data from a first data source and event data from a second data source may include one or more data fields common to the first and second event data the aggregation operation may be configured to identify one or more of those common data fields. In some embodiments, each data operation of the aggregation operation may produce a respective data result. The aggregation operation may include combining two or more of the data results produced by the various data operations. For example, the first data operation performed on the first event data may produce a first data result and the second data operation performed on the second event data may produce a second data result. The aggregation operation may include combining the first and second data results from the two operations to produce a final data result that includes processed data from both the first event data and second event data.

In some embodiments, the aggregation operation may combine the first and second data results based on the identified common field between the first and second event data. For example, the aggregation operation may include creating an output data structure including the first data result and the second data result (e.g. merging the first data result and second data result into a common document to be stored in a dynamic schema). In some embodiments, the output data structure may be based on the identified common field(s) between the first and second event data.

In some implementations, stream processor 200 may also include a timestamp component 240. The timestamp component 240 may timestamp the data from some point in time when the data was ingested. For example, timestamp may relate to the time in which the event data was written to the stream processing environment. In some embodiments, the timestamp component 240 may extract timestamp information from user-defined timestamps in the event data. Timestamp information of the event may be used by the windowing component 250. Windowing component 250 may analyze and perform processes based on one or more timing window-based operations. The window-based operations may be performed based on any suitable windowing scheme, for example, tumbling windows, hopping windows, etc. Time window bounds for the event data may be determined by the system or by the user. Based on the time window bounds, windowing component 250 may perform comparisons, string manipulations, expression matching, calculate metrics of grouped data (e.g., totals, averages, maximums, etc.), among other functions and/or processes for data which falls within the time window bounds. In some embodiments, if the timestamp of the event data is outside of the time window bound, then the event data may be pushed to the DLQ to later be inspected. Pushing event data whose timestamp is outside of the time window bound may ensure that the system does not stop or crash because of late data.

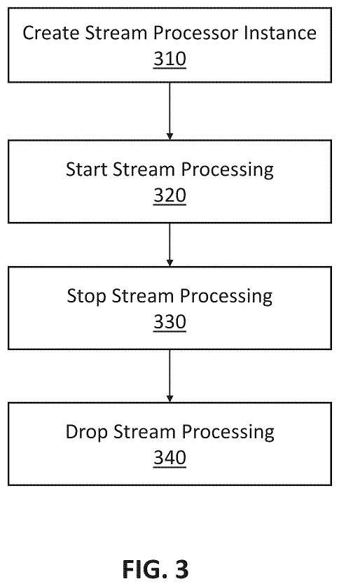

FIG. 3 is an example flow chart of the stream processor states, according to some embodiments. Prior to processing data stream, a stream processor instance may be created at block 310. The user may request creating a stream processor instance for a particular streams cluster. Creating the stream processor instance for a streams cluster may allow streams to be created, altered, and/or dropped, or may allow background operations associated with the stream cluster to be managed, started, and/or stopped. The stream processor instance may be associated with metadata information such as configuration metadata and information regarding the source and sink such as the named source and sink and credentials. The request to create a stream processor instance 310 may store the metadata in a meta store and may generate a connection string associated with a cloud provider. The connection string may include information regarding credentials and a hostname for the stream processor instance. For example, the connection string may be of the form:

mongodb://<user>:<password>@{XYZ}.a.query.mongodb.net

where XYS is the user provided hostname. Once the connect string is generated, the connection string may be used to resolve a request to one or more nodes of the distributed system. For example, the node may be in a requested region (e.g., closest region to the user). In some embodiments, the node may be a proxy node configured with a load balancer (e.g., HAProxy node) that may be configured to receive the query and forward it to a front-end of the system (e.g., front-end user interface 802 described below). The front-end may receive and use the hostname to receive tenant (e.g., customer) configuration information including, for example, roles, users, allowed IPs. The hostname may also be used to determine a storage configuration from the meta store (e.g., metadata cluster). In some embodiments, the stream processor instance may be a namespace and may not have dedicated resources or assets associated with the stream processor instance.

Once a stream processor instance is created, processing of a data stream may begin at block 320. The user may request to start stream processing. In some embodiments, stream processing may be performed within a stream processing environment (e.g., component 130). The user request may be processed by the stream processor manager, which may retrieve metadata relating to the source and sink from the meta store. The stream processor may then request resources from the resource manager for stream processing. The stream processor may then broker the request through the agent to start stream processing.

Stream processing may then be stopped at block 333. A user may request to stop stream processing at 330, which destroys the stream processor instance. A user may then request to drop stream process at block 340 which returns any resources and removes its definition.

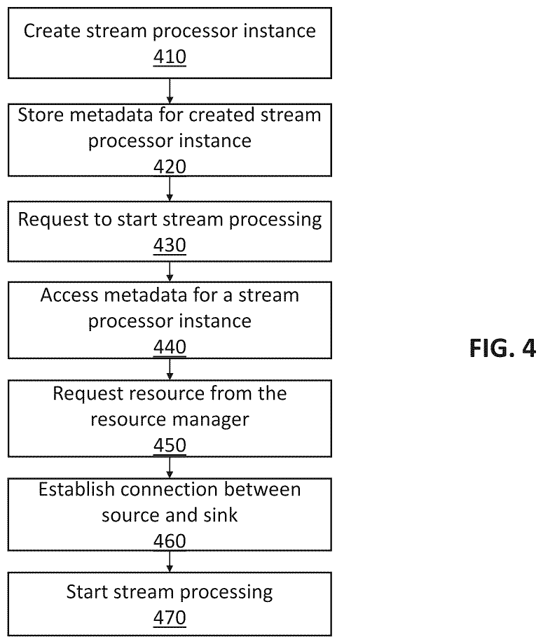

FIG. 4 is an example process of starting a stream processor for processing streaming data. Process 400 may begin at block 410 to create a stream processor instance. A user may request to create a stream processor instance. The stream processor instance may be associated with metadata information such as configuration metadata and information regarding the source and sink such as the named source and sink and credentials. Following the request to create a stream processor instance 410, metadata associated with the stream processor instance may be stored in a meta store and may generate a connection string associated with a cloud provider at block 420. The stream processor instance may be a namespace and may not have dedicated resources or assets associated with the stream processor instance.

Process 400 may continue to block 430 by receiving a request to start data stream processing, which the request may be processed by a stream manager. At block 440, the stream manager may retrieve metadata relating to the source and sink from the meta store. At block 450, the stream processor may then request resources from the resource manager for stream processing. At block 460, a connection between the source and sink may be established and then stream processing may start at block 470.

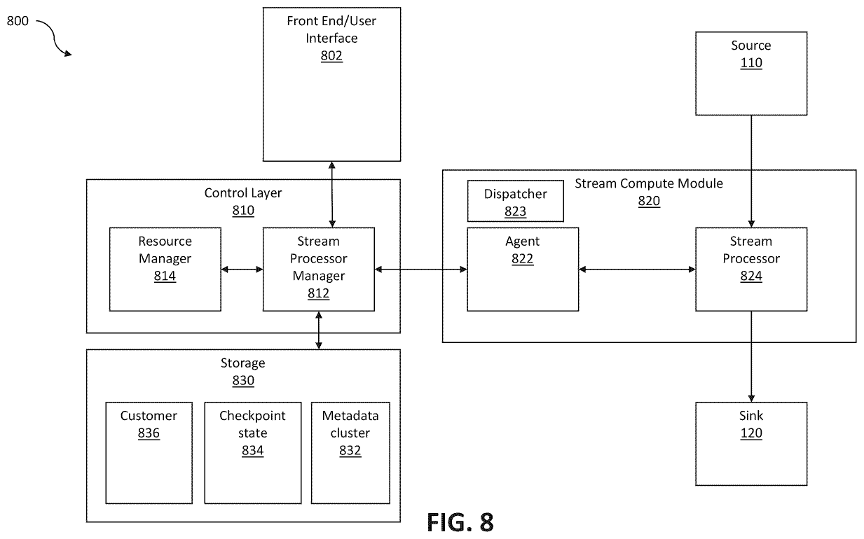

Referring back to FIG. 1, stream processing environment 130 may be implemented in any suitable architecture. FIG. 8 depicts an exemplary architecture 800 for implementing a stream processing environment configured to enable a user to manage one or more stream processors. Architecture 800 may include a front-end user interface 802, a control layer 810, a stream compute module 820, and storage 830, each configured to implement one or more aspects of a stream processing environment as described herein.

In some embodiments, front-end user interface 802 may facilitate communication between a user and the system and enable a user to manage the stream processing functions described herein. Front-end user interface 802 may receive information from devices configured to facilitate user interaction such as input devices, output devices or a combination thereof. Examples of input devices include, among others, keyboards, mouse devices, trackballs, microphones, kiosks, touch screens, printing devices, display screens, speakers, network interface cards, or any other suitable input device. Front-end user interface 802 allows users to exchange information and communicate with external entities, such as other users and other systems. It should be appreciated that interfaces that can implement various functionalities exposed to users and other entities generally can include graphical user interfaces, web-based interfaces, programmatic interfaces, mobile device interfaces, cloud-based management interfaces, cloud-based or other types of APIs, among others.

In some embodiments, front-end user interface 802 may facilitate the communication between the control layer 810 and a user. Front-end user interface 802 may be configured to receive information relating to manage various functions of the stream processing environment including, for example, creating a stream processor instance (e.g., as described with respect to FIG. 3), connecting to a created stream processor instance, creating a stream processor 824 (e.g., as described with respect to FIG. 4), managing one or more stream processors 824 (e.g., starting, stopping, dropping, configuring, etc.), and or any other functions of the stream processing environment. The information may include, for example, information related to data sources 110 and data sinks 120, stream processor configuration information, operations for a stream processor 824 to perform and associated configuration information (e.g., windowing type, window duration), or any other suitable information.

For example, in some embodiments, front-end user interface 802 may include a management interface for receiving the information relating to a stream processor instance to be created. The information may include data associated with data sources 110 and data sinks 120. The management interface may further be configured to generate connect strings for creating a stream processor 824 associated with the stream processor instance and cause the system to create the stream processor 824 based on the generated connect strings. For example, the management interface may cause the front-end user interface 802 to perform front-end processing of a request by the user and the information received from the user and provide that processed request and information to stream processor manager 812 to cause the system to create the stream processor 824 or perform any of the other functions described herein.

In some embodiments, the management interface may include a stream instance component to receive the information from the user, enable the user to manage the stream instance, and/or generate the one or more connection strings. For example, the user may provide a request and/or information associated with the request to the stream instance component via an input device of front-end user interface 802 to cause the stream instance component to perform the functions described herein. The management interface may further include a stream processor component to receive the one or more connection strings based on input from the user, cause the system to create a stream processor 824 based on the connection strings, and/or enable the user to manage the created stream processor. For example, the user may receive the connection strings from the stream instance component and may provide the connection strings (or cause the stream instance component to provide) to the stream processor component. Additionally, a user may provide one or more control inputs to the stream processor component to cause the stream processor component to perform the functions described herein.

In some embodiments, front-end user interface 802 may be configured to provide one or more outputs (e.g., via a display, audio output, etc.) related to the stream processor instances or stream processors of the system. For example, front-end user interface 802 may provide as output to the user a list of currently existing stream processor instances, currently running stream processors 824, one or more metrics associated with the stream processors 824 (e.g., source name, sink name, processes), outputs associated with the stream processing operations a stream processor is performing (e.g., published change streams), or any other suitable output.

In some embodiments, front-end user interface 802 may facilitate the communication between the control layer 810 and a user in any suitable manner. In some embodiments, front-end user interface 802 may be configured to receive text inputs from the user, audio inputs, or may include other user input components (e.g., buttons, sliders, drop-down menus) that may facilitate a user interacting with the system. In some embodiments, the management interface may be implemented as a command line interface (CLI), an application programming interface (API), or a graphical user interface (GUI) or a suitable combination thereof. For example, the management interface may be implemented as a CLI. Alternatively or additionally, a portion of the management interface may be implemented as one type of interface while a second portion may be implemented as a second type. For example, a stream instance component may be implemented as a CLI, whereas the stream processor component may be implemented as a GUI, although the technology is not limited in this respect.

In some embodiments, control layer 810 may include a stream processor manager 812 configured to manage various functions of the stream processing environment including, for example, creating a stream processor instance (e.g., as described with respect to FIG. 3), connecting to a created stream processor instance, creating a stream processor 824 (e.g., as described with respect to FIG. 4), managing one or more stream processors 824 (e.g., starting, stopping, dropping, configuring, etc.), and or any other functions of the stream processing environment. In managing the various functions of the stream processing environment, stream processor manager 812 may receive information from the front-end user interface 802. In some embodiments, the information may include a request to perform one of the functions (e.g., a Remote Procedure Call (RPC) request) of the stream processing environment and/or information associated with a request that was provided by a user to front-end user interface 802 as described above. When a request to perform one or more functions is received, stream processor manager 812 may communicate with other components in control layer 810 (e.g., resource manager 814), with components of the storage 830, and components of the stream compute module 820 to execute the one or more functions.

In some embodiments, the control layer 810 may additionally include resource manager 814 configured to manage resources to be used by one or more stream processors being executed by the system. Upon receiving a request to create a stream processor 824, stream processor manager 812 may communicate with resource manager 814 to request one or more resources (e.g., compute resources of a distributed system, nodes of the distributed system, provision resources, etc.) to be configured to perform the stream processing functions of stream processor 824. Similarly, when receiving a request to drop a stream processor 824, stream processor manager 812 may communicate with resource manager 814 to return the one or more resources of stream processor 824 to be available for use for other functions.

In some embodiments, architecture 800 may include a stream compute module 820 configured to perform the one or more operations of the stream processing system. Stream compute module 820 may include a stream processor 824 that has been created at the request of a user to perform one or more stream processing functions as described herein. Stream compute module 820 may further include agent 822 configured to broker communications between a stream processor 824 and the rest of the stream processing environment (e.g., with stream processor manager 812). For example, upon receiving a request for starting a stream processor, stream processor manager 812 may provide the request to agent 822 to establish a connection between source 110 and sink 120 to create stream processor 824 and start one or more of the processing functions described herein. Additionally or alternatively, in some embodiments agent 822 is configured to perform monitoring and diagnostic functions of one or more stream processors 824. Agent 822 may be configured to keep track of running stream processors 824, monitor them, report status changes and metrics, or any other suitable function. Agent 822 may be configured to publish information related to the running stream processors 824, for example, via cmoslib queue. In some embodiments, stream computer layer may include dispatcher 823 configured to manage agent 822 by initiating RPC requests, enable interactions between agent 822 and various message queues (e.g., cmoslib queuc), and receive events published to the message bus.

In some embodiments, storage 830 may include one or more metadata clusters 832 configured to store and provide metadata related to stream processor instances and stream processors for use by the stream processor manager 812 in performing the one or more functions. Storage 830 may store metadata clusters 832 as part of a connection registry to be accessed by stream processor manager 812 in creating, connecting, and/or managing stream processor instances and/or stream processors. For example, in creating a stream processor manager 812 may receive the request to create a stream processor instance and/or metadata related to the request including named sources and sinks, credentials, configuration information and any other suitable metadata.

Stream processor manager 812 may transmit the metadata to the metadata cluster 832 to store the metadata and enable a user to connect to and manage the stream processor instance, create and manage stream processors, and use the stream processors the perform any of the functions described herein. In addition to the one or more metadata clusters 832, storage 830 may be configured to store other information. For example, when a stream processor 824 is performing checkpointing operations, storage 830 may include checkpoint state storage 834 to store the various information related to the checkpoint stream processor 824 is establishing. In some embodiments, storage 830 may additionally be configured to store customer configuration details 836 for use by stream processor manager 812 or other suitable components. For example, customer configuration details 836 may include roles, users, allowed IPs or any other suitable information associated with a customer and the configuration that the customer may have set up. Storage 830 may be configured as an internal storage, distributed storage, cloud-based storage, or any other suitable storage architecture.

### Exemplary db.startStreamProcessor Flow

Returning to FIG. 4, at block 430 a user may provide a request to create a start a stream processor 824 within an established stream processor instance. The request (e.g., db.startStreamProcessor) may be provided to front-end user interface 802 for initial processing. For example, starting the stream processor may include initially creating the stream processor 824 to establish a connection between source 110 and sink 120. A request to create the stream processor 824 (db.createStreamProcessor) may be processed by front-end user interface 802 which may provide the create request to stream processor manager 812 (e.g., SPM.createStreamProcessor). Upon receiving the create request, stream processor manager 812, at block 440, may be configured to access one or more metadata clusters 832 associated with the stream processor instance to retrieve information for creating stream processor 824. For example, the information may include named sources and sinks, configuration details, credentials, or any other suitable information.

Stream processor manager 812, at block 450, may additionally request one or more resources for creating and running the stream processor from resource manager 814. At block 460, stream processor manager 812 may create stream processor 824 by establishing the connection between source 110 and sink 120 based on the information received at block 440 and using the resources allocated by resource manager 814 at block 450. At block 470, stream processor manager 812 may provide the processing request to stream processor 824 to perform one or more of the operations described herein. In some examples, this communication between stream processor manager 812 and stream processor 824 may be brokered through agent 822. Brokering the communication through agent 822 may include providing the request to dispatcher 823 to initiate a gRPC request to agent 822 to start stream processing using stream processor 824. As such, stream processor 824 may be configured to access data from source 110 and land processed data in sink 120 directly without brokering through agent 822.

Each created stream processor 824 may be configured to be created within the context of a database cluster and stream processor 824 may have read or write access to that cluster. Stream processor 824 may have additional permissions associated with the database cluster, may be configured to create collections, write to collections in the cluster (e.g., with $merge), subscribe to change streams for the cluster, or perform other operations associated with the cluster. In some embodiments, streaming pipeline stages that are configured to read or write data (e.g., $in, $lookup, $merge, $out, etc.) may be extended beyond the particular database cluster associated with stream processor 824 to other database clusters. For example, stream processor 824 may be configured to perform read or write operations to all data sources and sinks based on credentials brokered through agent 822.

FIG. 5 is an example process of pushing event data into a dead letter queue. Process 500 may begin at block 510 when the stream processor receives event data from the source. The stream processor may then attempt to serialize the event data. If the event data cannot be serialized at 520, then the event data may be pushed to the DLQ at block 550 to be further inspected. If the event data can be serialized at 520, then the serialized event data may be further processed at block 530 and the stream processor may then land processed data into data sink at block 540. In further embodiments, process 500 may push event data into the DLQ if the event data timestamp is outside of a time window boundary or if the event data does not conform to specified validation rules.

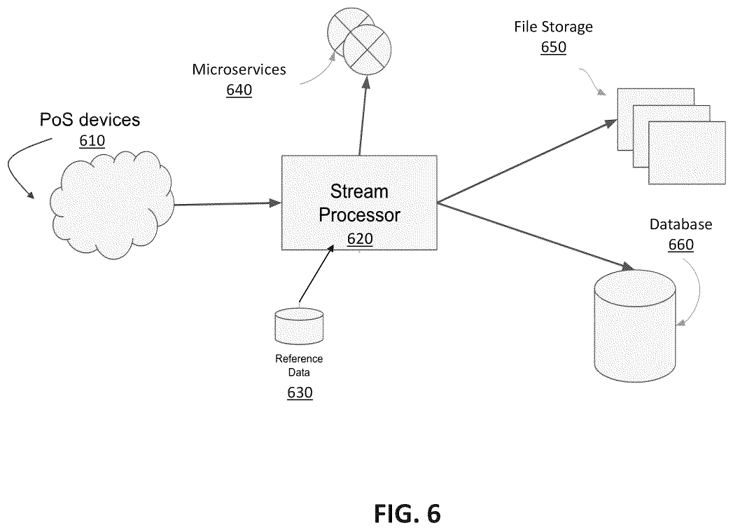

FIG. 6 is a block diagram of an example system configured to process data streams in near real-time for fraud detection. System 600 may include a PoS device 610 that may generate a data stream of event data. The data stream may be received by stream processor 620. Stream processor 620 use reference data 630 to process event data for fraud. If the processed event data has been identified as fraudulent by the stream processor 620, the stream processor may push the event data to the microservices 640 for further inspection. The microservices may inspect the potentially fraudulent event data and may provide notifications or account disablements based on the fraudulent event data. After processing the event data, stream processor 620 may land data into database 660. In some embodiments, applications running on end user devices may be programmed to use the data from the database 660 for underlying data management functions. For example, the data from the database 660 may be used for internal dashboards and metric views. Stream processor 620 may also land the processed data in a file storage 650. Events stored within the file storage 650 may be archived for regulatory inspection.

FIG. 7 is another block diagram of an example system 700 configured to perform stream processing. Stream processing environment 730 may be configured interact with various sources 710, 720 and sinks 740, 750. In some embodiments, streaming data may be provided to the stream processing environment by sources 710, 720. Sources 710, 720 may be a streaming platform, change stream, sensor, device, database, among others. Streaming processing environment 730 may process the received streaming data and land the processed data in in sink 740, 750. Sinks 740, 750 may be a database, data lake, change stream, streaming platform, among others. In some embodiments, the system 700 is configured to performing a chaining of operations on data from the sink 740. The output of the chaining of operations may be input into the source 710. In some embodiments, this chaining of operations may be implemented as part of an aggregation pipeline, for example, as described with respect to aggregation component 230 above. The one or more operations being performed in the chaining of operations may be executed or performed in different stages of the aggregation pipeline.

As an exemplary use case, the system may be configured to generate a change stream based on insert, update, and delete activity against a particular collection. The change stream may be a source that is mutated, joined, enriched (e.g., through a $lookup operation). The enriched change stream may be landed back into the change stream (as a sink) and the output of landing the enriched change stream back into the change stream may be provided as the source. In that way, the system may be able to monitor the change stream (or any other suitable source) continuously. Although described with respect to change streams, this is for exemplary purposes only.

### Exemplary Functions and Features

The table below provides exemplary features of the systems and techniques described herein. It can be appreciated that these features are outlined for exemplary purposes only and is not exhaustive of the functions that features that can be implemented by the system. It should also be appreciated that one or more of these functions and features may be used alone or in combination with any other functions or features.

| | Example | Atlas CLI Examples/ |
|---|---|---|
| Feature | function/configuration | Links/Details |
| Atlas Auth | Authenticate to Atlas | % atlas auth login |
| Stream instance | Configured to | % atlas streams |
| Creation/ | create/destroy/ | streamProcessingInstance |
| Manage- | manage streams | create |
| ment | in Atlas in some | StreamingDemo |
| | implementations. | % atlas streams |
| | Configured to | streamProcessingInstance |
| | create a new | drop |
| | instance for streams. | streamingDemo |
| | This may | |
| | be a namespace, | |
| | for example, | |
| | analogous to | |
| | creating a data | |
| | federation instance. | |
| | Configured | |
| | to return to the user very | |
| | quickly in some | |
| | implementations. | |
| | Drop is configured | |
| | to stop all | |
| | streams in the instance | |
| | and returns any | |
| | resources to the | |
| | pool and removes the | |
| | namespace in some | |
| | implementations. Drop | |
| | is configured to not | |
| | retain the state in some | |
| | implementations. | |
| List Streams | Configured to see | % atlas streams |
| Instances | the various | streamProcessingInstance |
| | stream instances | list |
| | that have been | { |
| | created. | name: StreamingDemo, |
| | | status: started |
| | | } |
| Connect String | Configured to | % atlas streams |
| | get the connect | streamProcessingInstance |
| | string. | describe |
| | | StreamingDemo |
| | | { |
| | | name: StreamingDemo, |
| | | standardSrv: |
| | | mongodb+srv:// |
| | | StreamingDemo.20xd |
| | | b.mongodb.net |
| | | } |
| Connection | Configured to | The connection |
| Registry | create a data | registry is |
| | source. Configured | configurable |
| | to allow for | Configured to |
| | configuring a | facilitate adding Kafka |
| | source Kafka | data sources as well. |
| | cluster and | Kafka sources |
| | the credentials | configured to be |
| | required in some | able to accept any |
| | implementations. | configuration |
| | It also is | parameter set here |
| | configured to | (credentials) |
| | allows for data | For $source, the user |
| | sinks in some | may specify |
| | implementations. | consumer properties. |
| | Configured to | For $emit, the |
| | allow the user to | user may specify |
| | specify if this is a source | producer properties. |
| | ($source) or a sink | |
| | ($emit/$merge) in some | |
| | implementations. | |
| | Configured to | |
| | not specify a | |
| | topic at this | |
| | level. Configured | |
| | to be cluster-level | |
| | security. This | |
| | name and the | |
| | topic name are | |
| | configured to | |
| | allow the user to | |
| | specify in the $source | |
| | configuration. Security | |
| | credentials may | |
| | be stored in the | |
| | existing MMS | |
| | system and may | |
| | not be in the | |
| | config object in | |
| | some implementations. | |
| | Data source/sink types | |
| | supported at | |
| | MDP may be: | |
| | Source: | |
| | $source: Kafka | |
| | $source: Change Stream | |
| | Sink | |
| | $emit: Kafka | |
| | $emit: Change Stream | |
| | $merge: Atlas | |
| | Collection | |
| | Authentication | |
| | may be (at a | |
| | minimum) support | |
| | SASL/SCRAM | |
| | but it's likely | |
| | customers will | |
| | want PLAIN as | |
| | well. | |
| DDL/Control | Commands to | createStreamProcessor |
| | define/create, | (‘mystream’) |
| | start, stop, and | mystream.stop( ) |
| | delete streams in | mystream.start( ) |
| | some implementations. | mystream.drop( ) |
| | Streams | system.streams.find( ) |
| | configured to run | |
| | backgrounded | |
| | from the shell. | |
| | A listing may | |
| | exist of all running | |
| | jobs/streams. | |
| Data inspection | Configured to | createStreamProcessor |
| | tail or watch | (“myKafka”, [ { |
| | (sample) a created | $source: { } ]); |
| | stream in the | myKafka.sample( ) |
| | MongoDB | |
| | shell in some | |
| | implementations. | |
| | This is a | |
| | beneficial activity | |
| | in developing | |
| | streams-the | |
| | ability to see | |
| | results and reason | |
| | about the | |
| | computation | |
| | being performed. | |
| | Configured | |
| | to .sample( ) a | |
| | stream when | |
| | a $merge is | |
| | present. | |
| Aggregation | Configured to | const p = [ |
| pipeline | define an | { $source: { } }, |
| | aggregation | { $match: { } }, |
| | pipeline that takes | { $window: { } }, |
| | input from $source | { $group: { } }, |
| | and sends | { $merge: { } } |
| | outputs to | ]; |
| | $emit/$merge in | createStream |
| | some implementations. | (‘mystream’ p); |
| | Configured to | |
| | support existing | |
| | grammar, | |
| | functionality, and | |
| | documentation | |
| | in some | |
| | implementations. | |
| | The individual | |
| | stages may be | |
| | evaluated using | |
| | Atlas Streams | |
| | $stage and $accumulator | |
| | support matrix | |
| Named | Configured to | See Connection |
| inputs and | name various | Registry above. The |
| outputs | Kafka connections | named connection |
| | and use | will be defined in |
| | them to define a | Atlas under ‘data |
| | stream in some | sources’ similar to |
| | implementations. | how Data Federation |
| | For example, | does it. |
| | so developers | |
| | do not have to | |
| | specify the | |
| | connection string | |
| | and credentials | |
| | for each stream. | |
| $source | May include | $source : |
| | Kafka support, | { connection : |
| | including the | { name: <named |
| | ability to set | connection>, |
| | consumer properties. | topic: xx, |
| | Configured to | config: |
| | reference a name | <consumer props> |
| | from the Connection | } |
| | Registry. | } |
| | A sample streaming | |
| | dataset | |
| | exists that the | |
| | developer may | |
| | use just to try | |
| | it out without | |
| | having a Kafka | |
| | instance. | |
| $emit | May include | $emit : { connection : |
| | Kafka support | { name: <named |
| | including the | connection>, |
| | ability to set the | topic: xx, |
| | producer properties. | config: |
| | Configured | <producer props> |
| | to reference a | } |
| | name from the | } |
| | Connection | |
| | Registry in some | |
| | implementations. | |
| $merge | Configured to | Materialized view |
| | materialize data | options for streams |
| | via merge to a | |
| | remote collection in | |
| | some implementations. | |
| | May support | |
| | upsert, and insert | |
| | modes (specifying | |
| | a key for | |
| | upsert required). | |
| | Materialized | |
| | views may be | |
| | consistent. | |
| $validate | Configured to | $validate: {$expr: {..} } |
| | utilize the | |
| | existing MongoDB | |
| | schema | |
| | validation paradigm | |
| | for streams in some | |
| | implementations. This | |
| | may be | |
| | implemented as a stage | |
| | in the aggregation | |
| | language. | |
| | Validation failures | |
| | for failed | |
| | messages may | |
| | be sent to a Dead | |
| | Letter Queue (DLQ). | |
| | MDP is configured | |
| | to support | |
| | query operator | |
| | validation in | |
| | some implementations | |
| | in some | |
| | implementations. | |
| Serialization | Configured to | |
| | support JSON | |
| | support, including | |
| | nested and | |
| | complex structures | |
| | in some | |
| | implementations. | |
| | If there is an | |
| | error with | |
| | serialization to | |
| | BSON then the | |
| | message may be | |
| | sent (with | |
| | headers and error | |
| | message) to a DLQ. | |
| Timestamps | Configured to | |
| | support both | |
| | Kafka timestamps | |
| | (produce time) and | |
| | timestamps in the | |
| | data in some | |
| | implementations. | |
| | Need string | |
| | functions for | |
| | date/time | |
| | parsing in some | |
| | implementations. | |
| | Timestamp | |
| | representations may | |
| | be configured | |
| | to support | |
| | millisecond | |
| | resolution (eg. | |
| | std::chrono:: | |
| | milliseconds or | |
| | similar). This | |
| | includes user | |
| | supplied timestamps, | |
| | window | |
| | size specifications, etc. | |
| State | Configured to | |
| management | restart processing | |
| and | from the recently | |
| recoverability | computed | |
| | result of a | |
| | window or other | |
| | processing in some | |
| | implementations. | |
| | Does not | |
| | require going | |
| | back and | |
| | reprocessing | |
| | data from the | |
| | previous Kafka | |
| | offset in some | |
| | implementations. | |
| $window or | Configured to | |
| $statefulWindow | support sliding, | |
| Or | tumbling windows | |
| $streamingWindow | with user- | |
| | defined timestamp | |
| | boundaries in | |
| | some implementations. | |
| | Configured to | |
| | support a dead | |
| | letter queue for | |
| | late arriving | |
| | data where | |
| | events may be | |
| | inspected by | |
| | the developer- | |
| | otherwise no | |
| | controls on the | |
| | window operations | |
| | for handling | |
| | it in some | |
| | implementations. | |
| User Facing | Configured to | testStream.stats( ) |
| Metrics | inspect a stream's | { |
| | status and/or | ok: 1, |
| | running state in | ns: ‘testStream’, |
| | some implementations. | messageCount: 0, |
| | Configured | /* the count of |
| | to see specific | messages through the |
| | streaming and | stream */ |
| | latency metrics | size: 0, |
| | associated with | /* average size |
| | the processing | of message */ |
| | of events in some | storageSize: 0, |
| | implementations. | /* total state |
| | Additionally, | storage size */ |
| | configured to | parallelism: 0, |
| | provide a metric | /* number of |
| | to help the | workers-the unit of |
| | user figure out | scale */ |
| | the lag of | maxParallelism: 0, |
| | messages coming | /* generally = |
| | into the | number of kafka |
| | system in some | partitions */ |
| | implementations. | pipeline: [ ] |
| | | } |
| Dead Letter | If there is a failure | |
| Queue | to process an | |
| | event, a DLQ may | |
| | be defined to | |
| | capture the event | |
| | payload and | |
| | processing failure | |
| | details (per | |
| | stream). | |
| | Late arriving data. | |
| | If a message | |
| | is observed with | |
| | a data field | |
| | outside the | |
| | current window | |
| | ($window) then | |
| | the data may be | |
| | pushed as-is to the DLQ. | |
| | There may be many | |
| | reasons/queues to | |
| | capture including: | |
| | Unable to serialize to | |
| | BSON | |
| | Late Arriving data | |
| | Validation failure | |
| | via $validate | |

Although the exemplary functions described in the above table may relate to one or more systems, it should be appreciated that the list of functions and features is not exhaustive and may include any additionally suitable functions to be executed by the system. Further, certain systems may not support one or more of the functions outlined in the above table. As such, various functions and features may be modified, removed, or included depending, for example, on the capabilities of the system in which the stream processing technology described herein is executed on.

### Exemplary System Implementations

As referenced above, it should be appreciated that the invention is not limited to executing on any particular system or group of systems. Also, it should be appreciated that the invention is not limited to any particular distributed architecture, network, or communication protocol.

Aspects of the present disclosure may be incorporated into or implemented by one or more systems. In some embodiments, aspects of the present disclosure may be incorporated into a database system, for example, an existing database system like MongoDB Atlas, Atlas Data Federation, Atlas Application Service, Atlas Serverless, or a database system to be developed in the future. In integrating aspects of the present disclosure into a database system like Atlas, aspects may be supplemented by additional existing architecture, features, or functions so as to better manage data streams and the stream processing functionality described herein. In some embodiments, aspects of the present disclosure may additionally or alternatively be integrated with or incorporated into data streaming platforms, for example, the existing Kafka platform or any other suitable streaming platform now existing or to be developed. In some embodiments, aspects of the present disclosure may be integrated with any other suitable system, including but not limited, cloud-based data processing entities, event generators, or any other suitable system or combination of systems thereof.

Various embodiments of the invention can be programmed using an object-oriented programming language, such as Java, C++, Ada, or C # (C-Sharp). Other programming languages may also be used. Alternatively, functional, scripting, and/or logical programming languages can be used. Various aspects of the invention can be implemented in a non-programmed environment (e.g., documents created in HTML, XML or other format that, when viewed in a window of a browser program, render aspects of a graphical-user interface (GUI) or perform other functions).

The system libraries of the programming languages are incorporated herein by reference. Various aspects of the invention can be implemented as programmed or non-programmed elements, or any combination thereof.

A distributed system according to various aspects may include one or more specially configured special-purpose computer systems distributed among a network such as, for example, the Internet. Such systems may cooperate to perform functions related to hosting a partitioned database, managing database metadata, monitoring distribution of database partitions, monitoring size of partitions, splitting partitions as necessary, migrating partitions as necessary, identifying sequentially keyed collections, optimizing migration, splitting, and rebalancing for collections with sequential keying architectures.

### Conclusion

Having thus described several aspects and embodiments of this invention, it is to be appreciated that various alterations, modifications and improvements will readily occur to those skilled in the art. Such alterations, modifications, and improvements are intended to be part of this disclosure and are intended to be within the spirit and scope of the invention. Accordingly, the foregoing description is by way of example only.

Use of ordinal terms such as “first,” “second,” “third,” “a,” “b,” “c,” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for creating and managing stream processors, the system comprising:
a management interface configured to:
receive information from a user relating to a stream instance, the information including data associated with one or more data sources and/or one or more data sinks;
enable the user to manage the stream instance;
generate one or more connect strings for creating a stream processor associated with the stream instance;
cause the system to create the stream processor associated with the created stream instance based on the one or more connect strings; and
enable the user to manage the created stream processor based on one or more control inputs received from the user.

2. The system of claim 1, wherein enabling the user to manage the stream instance comprises enabling the user to:
create the stream instance based on the received information from the user;
drop the stream instance based on the received information from the user; and
store the one or more connect strings for creating the stream instance and connection data associated with the one or more data sources and/or one or more data sinks in a connection registry.

3. The system of claim 2, wherein dropping the stream instance comprises stopping the stream processor associated with the stream instance and returning computational resources executing the stream instance to a pool of computational resources.

4. The system of claim 2, wherein the management interface is further configured to enable the user to manage the one or more connection strings and the connection data stored in the connection registry.

5. The system of claim 4, wherein the connection data includes credentials associated with the one or more data sources and/or the one or more data sinks.

6. The system of claim 4, wherein managing the one or more connection strings and the connection data stored in the connection registry comprises:
configuring a data store associated with the connection string and connection data as a data source or a data sink; and
specifying a configuration of the data store as a data source or a data sink.

7. The system of claim 1, wherein creating the stream processor comprises establishing a connection between a first data source of the one or more data sources and a first data sink of the one or more data sinks.

8. The system of claim 7, wherein managing the created stream processor comprises starting, stopping, and/or deleting the created stream processor.

9. The system of claim 7, wherein managing the created stream processor comprises defining one or more operations for the created stream processor to perform on event data received from the first data source prior to landing the event data in the first data sink.

10. The system of claim 9, wherein the one or more operations comprise an aggregation operation configured to process first event data from the one or more data sources and second event data received from the one or more data sources prior to landing the processed event data in the first data sink.

11. The system of claim 10, wherein the aggregation operation comprises:
a first operation to be performed on the first event data to obtain a first data result;
a second operation to be performed on the second event data to obtain a second data result; and
a merge operation to combine the first data result and the second data result to produce the processed event data.

12. The system of claim 11, wherein defining one or more operations comprises defining an output data structure for the processed event data including the first data result and the second data result.

13. The system of claim 1, wherein the management interface comprises:
a stream instance component configured to:
receive the information from the user;
enable the user to manage the stream instance; and
generate the one or more connection strings for creating the stream processor associated with the stream instance based on the information received from the user; and
a stream processor component configured to:
receive the one or more connection strings generated by the stream instance component based on input from the user;
cause the system to create the stream processor associated with the created stream instance based on the received one or more connection strings; and
enable the user to manage the created stream processor based on one or more control inputs received from the user.

14. The system of claim 13, wherein the stream instance component is a command line interface.

15. The system of claim 13, wherein the stream processor component is a driver interface.

16. The system of claim 1, wherein the management interface comprises an application programming interface configured to receive information from one or more data stream platforms.

17. A method for creating and managing stream processors, the method comprising:
using a management interface executed on a computing device configured to facilitate interaction between a user and the stream processors by:
receiving information from a user relating to a stream instance, the information including data associated with one or more data sources and/or one or more data sinks;
enabling the user to manage the stream instance;
generating one or more connect strings for creating a stream processor associated with the stream instance;
causing creation of the stream processor associated with the created stream instance based on the one or more connect strings; and
enabling the user to manage the created stream processor based on one or more control inputs received from the user.

18. The method of claim 17, wherein enabling the user to manage the stream instance comprises enabling the user to:
create the stream instance based on the received information from the user;
drop the stream instance based on the received information from the user; and
store the one or more connect strings for creating the stream instance and connection data associated with the one or more data sources and/or one or more data sinks in a connection registry.

19. The method of claim 18, wherein enabling the user to manage the stream instance comprises enabling the user to manage the one or more connection strings and the connection data stored in the connection registry.

20. The method of claim 19, wherein managing the one or more connection strings and the connection data stored in the connection registry comprises:
configuring a data store associated with the connection string and connection data as a data source or a data sink; and
specifying a configuration of the data store as a data source or a data sink.

21. The method of claim 17, wherein creating the stream processor comprises establishing a connection between a first data source of the one or more data sources and a first data sink of the one or more data sinks.

22. The method of claim 21, wherein managing the created stream processor comprises defining one or more operations for the created stream processor to perform on event data received from the first data source prior to landing the event data in the first data sink.

23. The method of claim 22, wherein the one or more operations comprises an aggregation operation configured to process first event data from the one or more data sources and second event data received from the one or more data sources prior to landing the processed event data in the first data sink.
